(19) United States
(12) Patent Application Publication
(10) Pub. No.: US 2024/0356140 A1
(43) Pub. Date: Oct. 24, 2024

(54) BATTERY PACK FOR ELECTRIC VEHICLE AND ELECTRIC VEHICLE COMPRISING SAME

(71) Applicants: AULTON NEW ENERGY AUTOMOBILE TECHNOLOGY CO., LTD., Guangzhou, Guangdong (CN); SHANGHAI DIANBA NEW ENERGY TECHNOLOGY CO., LTD., Shanghai (CN)

(72) Inventors: Jianping Zhang, Shanghai (CN); jiawei Chu, Shanghai (CN); Ming Zhu, Shanghai (CN)

(21) Appl. No.: 18/575,822

(22) PCT Filed: Dec. 12, 2022
(86) PCT No.: PCT/CN2022/138324

§ 371 Date: Dec. 30, 2023

(30) Foreign Application Priority Data
Dec. 26, 2021 (CN) 202111606763.7
Jul. 27, 2022 (CN) 202210894252.8

(51) Int. Cl. H01M 50/249; B60K 1/04; B60L 50/64; B60L 53/80; H01M 10/613; H01M 10/625; H01M 10/6568; H01M 50/204; H01M 50/258; H01M 50/262; H01M 50/271; H01M 50/291; H01M 50/296

(52) U.S. Cl. CPC H01M 50/249; B60K 1/04; B60L 50/64; H01M 10/613; H01M 10/625; H01M 10/6568; H01M 50/204; H01M 50/258; H01M 50/262; H01M 50/271; H01M 50/291; H01M 50/296; B60L 53/80; H01M 2220/20

(57) ABSTRACT

Disclosed in the present invention are a battery pack for an electric vehicle, and an electric vehicle comprising same. The battery pack for the electric vehicle comprises: a plurality of battery accommodating areas, which are arranged in a width direction of the electric vehicle, the plurality of battery accommodating areas comprising a middle accommodating area and side accommodating areas, and each battery accommodating area accommodating multiple layers of battery modules; and lock connection structures, which are used for matching locking mechanisms on the electric vehicle so as to lock the battery pack on the electric vehicle, the space in a vertical direction is fully utilized, the accommodating number of the battery modules is increased, the capacity of the battery pack is thus improved, the arrangement of the battery modules is rational, and the size of the battery pack in a horizontal direction is not increased.

The present application claims the priority of Chinese patent application CN2022108942528 filed on Jul. 27, 2022, and the priority of Chinese patent application CN2021116067637 filed on Dec. 26, 2021. The contents of the Chinese patent applications are incorporated herein by reference in their entireties.

### TECHNICAL FIELD

The present disclosure relates to a battery pack for electric vehicle and an electric vehicle comprising same.

### BACKGROUND

The existing battery pack installation method of electric vehicles is generally divided into fixed and interchangeable, wherein the fixed battery pack is generally fixed on the vehicle, and the vehicle is directly used as the charging object when charging. For interchangeable battery pack, a movable installation method is generally used, and the battery pack can be removed and replaced with a new battery pack at any time. When the battery pack is installed in this movable way, the battery pack is generally locked and installed on the bottom of the electric vehicle by means of a locking mechanism, when removing the battery pack from the locking mechanism, an external unlocking mechanism is required to act on the locking mechanism on the electric vehicle to unlock the battery pack from the locking mechanism, and then take out the battery pack.

Currently, battery modules are arranged in the horizontal plane of the battery pack case along the horizontal direction, if the battery power is increased by increasing the number of battery modules, it will lead to a larger size of the battery pack in the horizontal direction, which does not meet the vehicle specifications. Due to the size of the battery pack and the limitation of its internal space, the number of battery modules in the battery pack cannot be increased, thus the power of the battery pack cannot be increased, and thus the driving range of the electric vehicle cannot be improved, which need to replace the battery pack frequently.

### CONTENT OF THE PRESENT INVENTION

The technical problem to be solved in the present disclosure is to overcome the defects of the prior art in that the number of battery modules arranged along the horizontal direction in the battery pack is limited, which makes it impossible to increase the power of the battery pack and to improve the driving range of the electric vehicle, and the replacement of the battery pack is frequent, hence providing a battery pack for electric vehicle and an electric vehicle comprising same.

The present disclosure solves the technical problem by the following technical solutions:
A battery pack for electric vehicle, comprising:
a plurality of battery accommodating areas, arranged in a width direction of the electric vehicle, the plurality of the battery accommodating areas comprises a middle accommodating area and side accommodating areas, each of the battery accommodating area accommodates multiple layers of battery modules;
locking connection structures, used for matching locking mechanisms on the electric vehicle to lock the battery pack on the electric vehicle, the locking connection structure is located in the area between the middle accommodating area and the side accommodating area or the locking connection structure is located above the area between the middle accommodating area and the side accommodating area.

In this solution, the above structure form is adopted, the plurality of battery accommodating areas are arranged in the width direction of the electric vehicle and used to accommodate multiple layers of battery modules, so that the space in a vertical direction is fully utilized, the arrangement of battery modules in the vertical direction within the existing horizontal plane is increased, the accommodating number of the battery modules is increased, the capacity and the energy density of the battery pack for electric vehicle are thus improved, and the arrangement of battery modules is reasonable, which does not increase the size of the battery pack for electric vehicle in the horizontal direction, and conforms the vehicle usage specifications. At the same time, the locking connection structure is arranged in the gap area between the middle accommodating area and the side accommodating area or above the gap area, which makes the structure compact and makes the space utilization high, this allows for the full utilization of the space on both sides of the electric vehicle and below the electric vehicle to store and accommodate more battery modules, which further increases the power and energy density of the battery pack for electric vehicle, and increases the driving range of the electric vehicle, thereby reducing the number of battery pack replacements for electric vehicle.

Preferably, the battery pack for electric vehicle comprises multiple layers of accommodation cases, each of the accommodation case is used to accommodate the battery module, and two adjacent layers of the accommodation cases are connected to each other by a connecting structure.

In this solution, the above structure form is adopted, each accommodation case is used to accommodate battery modules to achieve stacked settings, so that the space in a vertical direction is fully utilized, the accommodating number of the battery modules is increased,, which further increases the power of the battery pack for electric vehicle, makes higher use of space, achieves longer travel distances for the electric vehicle and reduces the number of battery pack replacements. At the same time, two adjacent layers of the accommodation cases are connected to each other by the connecting structure, which effectively strengthens the structural connection and provides high stability.

Preferably, the accommodation case on the top layer comprises at least one case cover and a partition structure extending in a horizontal direction, and the partition structure is connected to adjacent lower accommodation case.

In this solution, the above structure form is adopted, the connection between adjacent upper and lower accommodation cases is achieved through the partition structure extending in the horizontal direction, and each layer of the accommodation case can accommodate battery modules, which realizes the arrangement of the battery modules in the vertical direction, so that the space in a vertical direction is fully utilized, the accommodating number of the battery modules is increased, which increases the capacity of the battery pack for electric vehicle.

Preferably, the partition structure comprises at least two partition frames, the partition frames are arranged at intervals along the width direction of the electric vehicle and used to accommodate the battery modules, and two adjacent partition frames are connected by means of a gap connection structure and form a gap.

In this solution, the above structure form is adopted, the partition frames are used to carry the battery modules, and the partition frames are connected by means of the gap connection structure so that the battery modules are arranged at intervals along the width direction of the electric vehicle. At the same time, the structure is connected with high strength, more stable and reliable.

Preferably, at least one of the battery module is accommodated on the partition frame between the two gap connection structures.

In this solution, the above structure form is adopted, at least one battery module is placed in the space formed by two gap connection structures, and the partition frame and the case cover, which realizes high space utilization rate, realizes the accommodating number of the battery modules, and improves the endurance mileage of the electric vehicle.

Preferably, the gap connection structure extends along the vertical direction and is connected to the adjacent lower accommodation case, and the gap connection structure is provided with a number of locking connecting members on top.

In this solution, the above structure form is adopted, the gap connection structure extends along the vertical direction and is connected to the lower accommodation case, which makes the connection between the upper and lower layers of the accommodation case stable, and makes the battery pack case compact in structure. In addition, the gap connecting structure can separate the upper and lower accommodation cases, and separate the multiple layers of battery modules arranged along the width direction of the electric vehicle in the horizontal direction, which ensure the safety and stability of the battery modules.

In addition, a number of the locking connecting members will be arranged at the top of the gap connection structure and used for locking cooperation with the locking mechanism at the bottom of the vehicle body beam, so that the space below the vehicle body beam can be utilized, the battery pack for electric vehicle can accommodated more battery modules, the electric vehicle can travel longer, and the replacement times of the battery pack can be reduced. The center of gravity of the battery pack for electric vehicle can be effectively reduced, which increases the stability of the battery pack for electric vehicle and improves the stability and safety of the electric vehicle with a large space.

Preferably, a number of the locking connecting members are connected to the gap connection structure by means of a U-shaped connecting plate, and two ends of the locking connecting member are threaded through the U-shaped connecting plate.

In this solution, the above structure form is adopted, a number of the locking connecting members are installed on the U-shaped connecting plate, and then the U-shaped connecting plate is installed on the gap connection structure, so as to install and connect a number of the locking connecting members. At the same time, the two ends of the locking connecting member are fixed on two sides of the U-shaped connecting plate respectively, so that the locking connecting members can achieve bilateral suspension when it is locked and cooperated with the locking mechanism, which makes the locking more stable and reliable, and the overall installation of the locking connecting members improves the locking and cooperating accuracy.

Preferably, two ends of the top of the U-shaped connecting plate are both provided with a first bending part extending in the horizontal direction, and the two first bending parts extend in opposite directions and respectively abut against the gap connection structure.

In this solution, the above structure form is adopted, the first bending parts will abut against the top of the gap connection structure and connect with the gap connection structure, so that the contact area is larger, the connecting strength between the U-shaped connecting plate and the gap connection structure is effectively strengthened, and the locking stability of the electric vehicle is improved. At the same time, the structure is simple and easy to be processed and manufactured.

Preferably, the gap connection structure comprises two division parts arranged at intervals, the division part extend along the length direction of the electric vehicle, and the gap is located between the two division parts.

In this solution, the above structure form is adopted, two adjacent battery modules arranged along the width direction of the electric vehicle are divided by the two division parts arranged at intervals, and the U-shaped connecting plate and a number of the locking connecting members are arranged in the two division parts arranged at intervals, so that the space utilization rate is higher, the connecting strength is high and the structure is simple.

Preferably, the top of the division part is provided with a second bending part extending outward in the horizontal direction, and the second bending parts of the two division parts extend in opposite directions and abut against the top surface of the case cover, and/or, the bottom of the division part is provided with a third bending part extending inward in the horizontal direction, and the third bending parts of the two division parts are oppositely arranged and connected to the bottom surface of the lower accommodation case.

In this solution, the above structure form is adopted, the division part is connected to the top surface of the case cover through the second bending part, which makes the contact area larger, effectively strengthens the connecting strength of the case cover and the gap connection structure, and improves the stability of the battery pack for electric vehicle. At the same time, the structure is simple and easy to process and make.

In addition, the division part is connected to the bottom surface of the lower accommodation case by means of the third bending section, which makes the contact area larger, effectively strengthens the connecting strength between the lower accommodation case and the gap connection structure, and improves the stability of the battery pack for electric vehicle. At the same time, the structure is simple and easy to be processed and manufactured.

Preferably, the gap connection structure further comprises a first reinforcing plate, and the first reinforcing plate is located at the gap and connected with the two division parts, and/or, two ends of the partition frame are both provided with a second reinforcing plate, and the two second reinforcing plates are respectively connected to two ends of the division part.

In this solution, the above structure form is adopted, the first reinforcing plate has a strengthening effect, which effectively strengthens the overall structural connecting strength of the gap connection structure and improves the stability of the battery pack for electric vehicle.

In addition, the second reinforcing plate has a strengthening effect, which effectively strengthens the connecting strength of the partition frame and the gap connection structure, and improves the stability of the battery pack for electric vehicle. At the same time, the second reinforcing plate has the function of shielding and isolating, and the battery modules placed on the partition frame will be located between two second reinforcing plates.

Preferably, the partition frame is provided with a first lightening hole and/or a first wire-passing hole, and/or, the gap connection structure is provided with a second lightening hole and/or a second wire-passing hole.

In this solution, the above structure form is adopted to further achieve a lighter weight of the battery pack for electric vehicle. At the same time, it is convenient for cables to pass through, and the installation and connection are very convenient.

Preferably, the partition structure further comprises a connecting beam, the connecting beam passes through and is connected to the gap connection structure, and the connecting beam is connected to at least two of the partition frames.

In this solution, the above structure form is adopted, the connecting beam has a strengthening function, which further strengthens the connecting strength of multiple partition frames and improves the stability of the battery pack for electric vehicle.

Preferably, the battery pack for electric vehicle further comprises at least one lower casing, the lower casing is connected to the bottom surface of the partition structure, and a lower accommodating cavity is formed between the lower casing and the partition structure, and the case cover is connected to the top surface of the partition structure, and an upper accommodating cavity is formed between the case cover and the partition structure.

In this solution, the above structure form is adopted, the partition structure is used for partition upper and down to form the upper accommodating cavity and the lower accommodating cavity, the lower accommodating cavity is used for accommodating the lower battery modules, and the upper accommodating cavity is used for accommodating the upper battery modules, which greatly improves the safety and stability of the battery pack for electric vehicle. At the same time, the structure is simple and the installation and arrangement are very convenient.

Preferably, the lower casing is internally provided with a matching structure connected with the gap connection structure, and the matching structure comprises an inverted U-shaped plate and a connecting pillar, two ends of the bottom of the inverted U-shaped plate are both provided with a fourth bending part extending in the horizontal direction, and the two fourth bending parts extend in opposite directions and respectively abut against the lower casing, and the connecting pillar is located within the inverted U-shaped plate, and the bottom of the connecting pillar is connected to the lower casing, and the top of the connecting pillar is connected to the top of the inverted U-shaped plate and the bottom of the gap connection structure.

In this solution, the above structure form is adopted, the inverted U-shaped plate is connected to the lower casing by means of the fourth bending part at two ends, which makes the contact area larger, effectively strengthens the overall structural connecting strength of the lower casing and improves the stability of the battery pack for electric vehicle. At the same time, the connecting pillar is arranged in the inverted U-shaped plate, which is convenient for connection and installation from the bottom of the lower casing, so that the installation and connection are very convenient, and the structural connecting strength can be strengthened. The connecting pillar can also be used for sealing treatment to prevent internal corrosion of the case, which further improves the usage time of the battery pack for electric vehicle.

Preferably, the top of two side walls extending along the length direction of the battery pack for electric vehicle on the lower casing are both provided with extension parts extending inward in the horizontal direction, and the extension parts are connected with the bottom surface of the partition structure.

In this solution, the above structure form is adopted, the extension part extending inward along the horizontal direction is attached and connected to the bottom surface of the partition structure, which effectively strengthens the connecting strength between the lower casing and the partition structure, and improves the stability of the battery pack for electric vehicle.

Preferably, the extension part and/or the partition structure are provided with a thickened plate, the thickened plate, the extension part and the partition structure are connected by fasteners.

In this solution, the above structure form is adopted, the thickened plate can effectively strengthen the local structural strength between the extension part and the partition structure, which further strengthens the connecting strength between the lower casing and the partition structure and improves the stability of the battery pack for electric vehicle.

Preferably, the position of the lower casing corresponding to the gap is provided with an upward extending sealing plate, and the sealing plate covers the gap at the corresponding position and is connected with the gap connection structure.

In this solution, the above structure form is adopted, the lower casing is connected to the upper accommodation case as a whole by means of the sealing plate, which further improves the structural strength of the interconnection of the multi-layer accommodation cases and ensures the overall strength of the battery pack for electric vehicle. At the same time, the sealing plate has a protective function and is used to cover the gap.

Preferably, the battery pack for electric vehicle further comprises a battery-side electrical connector for electrical connection with a vehicle-side electrical connector, and the battery-side electrical connector is connected to the accommodation case and electrically connected with multiple layers of the battery modules;

and/or, the battery pack for the electric vehicle further comprises a battery-side liquid-cooled connector for connecting with a vehicle-side liquid-cooled connector, and the battery-side liquid-cooled connector is arranged on the accommodation case.

In this solution, the above structure form is adopted, battery-side electrical connector is electrically connected to the vehicle-side electrical connector and used to supply power to the electric vehicle.

In addition, the battery-side liquid-cooled connector is connected to the vehicle-side liquid-cooled connector to cool the battery pack for electric vehicle.

An electric vehicle, it comprises the battery pack for electric vehicle as described above, and the battery pack for electric vehicle is removably connected to the electric vehicle.

In this solution, the above structure form is adopted, the plurality of battery accommodating areas are arranged in the width direction of the electric vehicle and used to accommodate multiple layers of battery modules, so that the space in a vertical direction is fully utilized, the arrangement of battery modules in the vertical direction within the existing horizontal plane is increased, the accommodating number of the battery modules is increased, the capacity and the energy density of the battery pack for electric vehicle are thus improved, and the arrangement of battery modules is reasonable, which does not increase the size of the battery pack for electric vehicle in the horizontal direction, and conforms the vehicle usage specifications. At the same time, the locking connection structure is arranged in the gap area between the middle accommodating area and the side accommodating area or above the gap area, which makes the structure compact and makes the space utilization high, this allows for the full utilization of the space on both sides of the electric vehicle and below the electric vehicle to store and accommodate more battery modules, which further increases the capacity and energy density of the battery pack for electric vehicle, and increases the driving range of the electric vehicle, thereby reducing the number of battery pack replacements for electric vehicle.

On the basis of common sense in the field, the above-mentioned preferred conditions can be arbitrarily combined to obtain the preferred examples of the present invention.

The positive progress effect of the present invention is:

The battery pack for electric vehicle and the electric vehicle comprising same of the present invention, the plurality of battery accommodating areas are arranged in the width direction of the electric vehicle and used to accommodate multiple layers of battery modules, so that the space in a vertical direction is fully utilized, the arrangement of battery modules in the vertical direction within the existing horizontal plane is increased, the accommodating number of the battery modules is increased, the capacity and the energy density of the battery pack for electric vehicle are thus improved, and the arrangement of battery modules is reasonable, which does not increase the size of the battery pack for electric vehicle in the horizontal direction, and conforms the vehicle usage specifications. At the same time, the locking connection structure is arranged in the gap area between the middle accommodating area and the side accommodating area or above the gap area, which makes the structure compact and makes the space utilization high, this allows for the full utilization of the space on both sides of the electric vehicle and below the electric vehicle to store and accommodate more battery modules, which further increases the capacity and energy density of the battery pack for electric vehicle, and increases the driving range of the electric vehicle, thereby reducing the number of battery pack replacements for electric vehicle.

### BRIEF DESCRIPTION OF THE DRAWINGS

FIG. 1 is a schematic diagram of the structure of the battery pack for electric vehicle connected to the vehicle body beam according to an embodiment of the present invention, in which the locking mechanism is omitted.

FIG. 2 is a schematic diagram of the structure of the battery pack for electric vehicle according to an embodiment of the present invention.

FIG. 3 is a schematic diagram of an exploded structure of the battery pack for electric vehicle according to an embodiment of the present invention.

FIG. 4 is a schematic diagram of an exploded structure of the battery pack for electric vehicle from another perspective according to an embodiment of the present invention.

FIG. 5 is a schematic diagram of the internal structure of the battery pack for electric vehicle according to an embodiment of the present invention.

FIG. 6 is a schematic diagram of part of the structure of the battery pack for electric vehicle according to an embodiment of the present invention.

FIG. 7 is a partial enlarged view of part A in FIG. 5.

FIG. 8 is a partial enlarged view of part B in FIG. 5.

FIG. 9 is a schematic diagram of the structure of the partition structure, the first reinforcing rib and the second reinforcing rib according to an embodiment of the present invention.

FIG. 10 is a cross-sectional view of the battery pack for electric vehicle according to an embodiment of the present invention.

FIG. 11 is a schematic diagram of the structure of a quick-change bracket and the vehicle body beam according to an embodiment of the present invention.

### DESCRIPTION OF REFERENCE NUMERALS

battery pack for electric vehicle 1
middle accommodating area 11
side accommodating area 12
locking connection structure 2
accommodation case 3
case cover 31
upper accommodating cavity 311
partition structure 32
partition frame 321
second reinforcing plate 3211
first lightening hole 3212
first wire-passing hole 3213
gap connection structure 322
division part 3221
second bending part 32211
third bending part 32212
connecting block 3222
first reinforcing plate 3223
second lightening hole 3224
second wire-passing hole 3225
end sealing plate 3226
locking connecting member 323
U-shaped connecting plate 324
first bending part 3241
connecting beam 325
lower casing 4
lower accommodating cavity 41
matching structure 42
inverted U-shaped plate 421
fourth bending part 4211
connecting pillar 422
extension part 43
thickened plate 44
sealing plate 45
first reinforcing rib 46
second reinforcing rib 47
battery-side electrical connector 5
battery-side liquid-cooled connector 6
battery module 10
vehicle body beam 100
locking mechanism 101

### DETAILED DESCRIPTION OF THE PREFERRED EMBODIMENT

The present invention will be more clearly and completely described below by means of embodiments and in conjunction with the accompanying drawings, but the present invention is not limited to the scope of the embodiments.

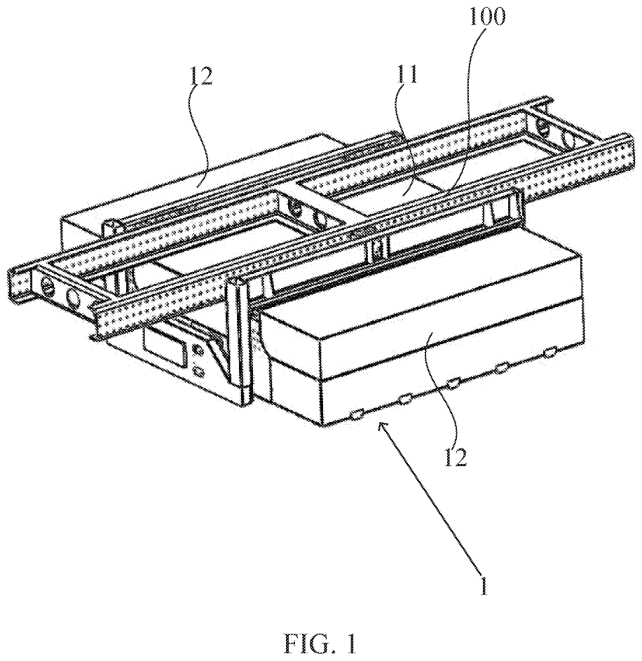

The embodiment of the present invention discloses an electric vehicle, which is a commercial vehicle such as a heavy truck or a light truck. As shown in FIGS. 1 to 11, the electric vehicle comprises a vehicle body beam 100 and a battery pack 1 for electric vehicle, and the battery pack 1 for electric vehicle is removably connected to the vehicle body beam 100 of the electric vehicle. The battery pack 1 for electric vehicle is connected to the vehicle body beam 100 in a removable way, thus enabling the replacement and maintenance of the battery pack 1 for electric vehicle.

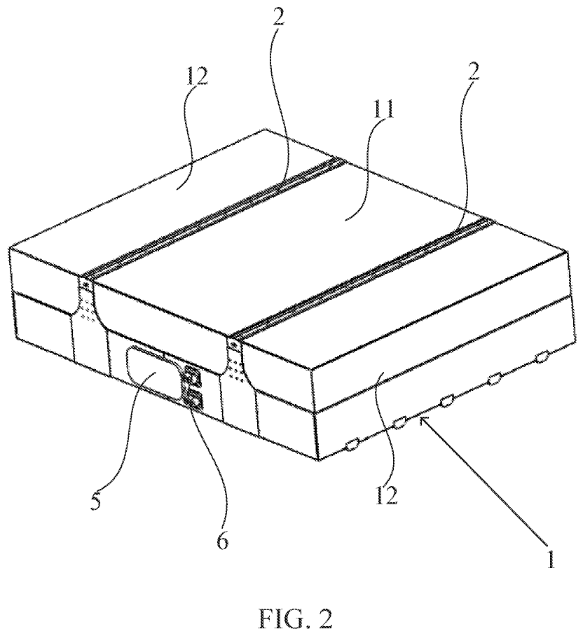

As shown in FIGS. 1 and 2, the battery pack 1 for electric vehicle comprises a locking connection structure 2 and a plurality of battery accommodating areas, and the plurality of battery accommodating areas are arranged in a width of the electric vehicle, and the plurality of battery accommodating areas comprises a middle accommodating area 11 and a side accommodating area 12, and each of the battery accommodating area accommodates multiple layers of battery modules 10. The locking connection structure is used for matching a locking mechanism on the electric vehicle to lock the battery pack to the electric vehicle, and the locking connection structure 2 is located in the area between the middle accommodating area 11 and the side accommodating area 12 or the locking connection structure 2 is located above the area between the middle accommodating area 11 and the side accommodating area 12.

Specifically, the number of battery accommodating areas is three, and the three battery accommodating areas comprise one middle accommodating area 11 and two side accommodating areas 12, and the two side accommodating areas 12 are respectively arranged on two sides of the middle accommodating area 11, and a gap area is formed between them. The locking connection structure 2 is arranged in or above the gap area between the middle accommodating area 11 and the side accommodating area 12, so that the structure is more compact. In this embodiment, as shown in FIG. 2, the locking connection structure 2 is provided in two gap areas between the middle accommodating area 11 and the side accommodating area 12, and a gap connection structure 322 is provided in both gap areas.

The vehicle body beam 100 is provided with a locking mechanism 101, and the battery pack 1 for electric vehicle is locked and matched with the locking mechanism 101 by means of the locking connection structure 2 to achieve the aforementioned removable connection. At the same time, the plurality of battery accommodating areas are arranged along the width direction of the electric vehicle and used for accommodating multiple layers battery modules 10, so that more battery modules 10 can be stored and accommodated by utilizing the space on both sides of the electric vehicle, thus realizing the longer travel distances of the electric vehicle and reducing the replacement times of the electric vehicle; and it can realize compact structure and high space utilization, so that the space at both sides and below the electric vehicle can be fully utilized to store and accommodate more battery modules 10, which further increases the power and energy density of the battery pack for electric vehicle, and increases the driving range of the electric vehicle, thereby reducing the number of battery pack replacements for the electric vehicle.

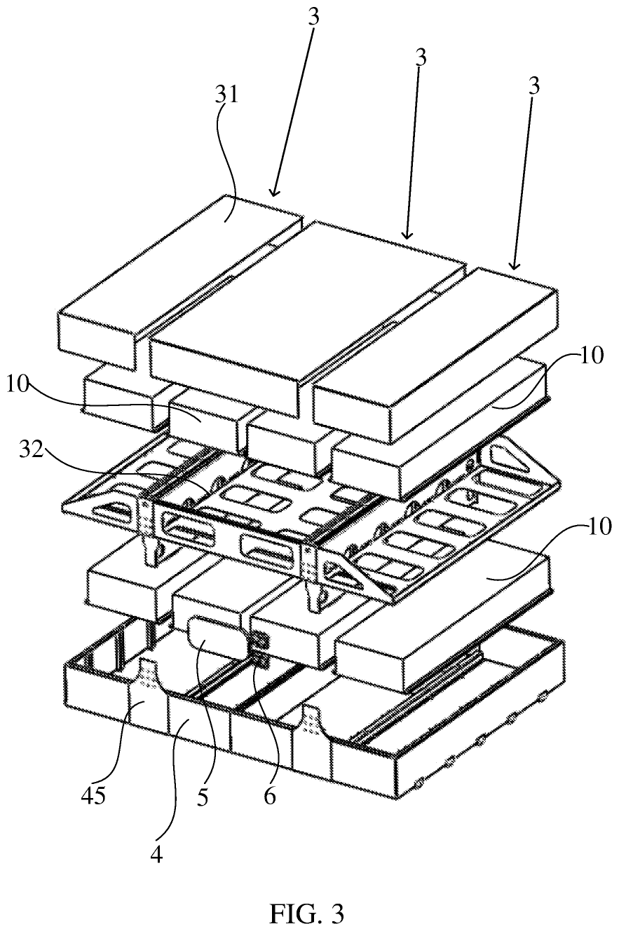

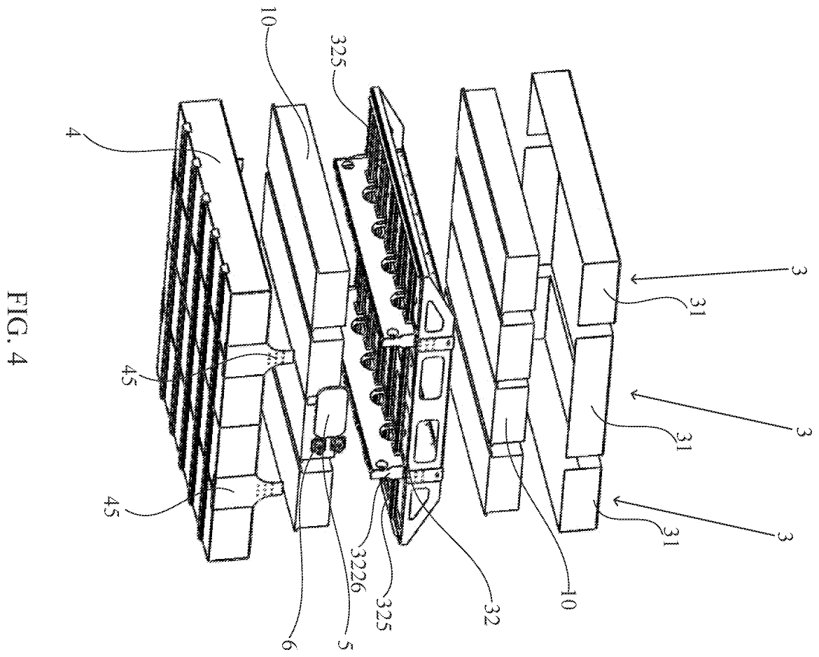

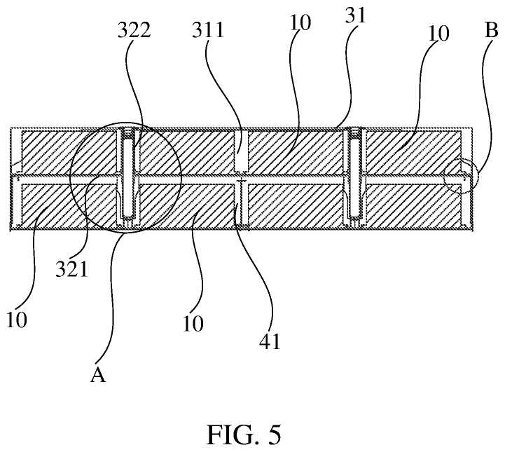

As shown in FIG. 3, FIG. 4 and FIG. 5, the battery pack 1 for electric vehicle comprises multiple layers of accommodation cases 3, each of the accommodation case 3 is used to accommodate the battery modules 10, and the middle accommodating area 11 and the side accommodating area 12 corresponding to each layer of the accommodation case 3 respectively accommodate at least one battery module, and two adjacent layers of the accommodation cases 3 are connected to each other by a connecting structure. Each accommodation case 3 is used for accommodating the battery module 10, so that each battery accommodating area is provided with multiple layers of accommodation cases 3 for accommodating the battery modules 10, and each battery accommodating area is provided with multiple layers of battery modules 10 to realize stacked settings, so that the space in a vertical direction is fully utilized, the arrangement of battery modules 10 in the vertical direction within the existing horizontal plane is increased, the accommodating number of the battery modules 10 is increased, the capacity and the energy density of the battery pack 1 for electric vehicle are thus improved, and the arrangement of battery modules 10 is reasonable, which does not increase the size of the battery pack 1 for electric vehicle in the horizontal direction, and conforms the vehicle usage specifications, increases the driving range of the electric vehicle, and reduces the number of battery pack replacements for electric vehicle. At the same time, two adjacent layers of the accommodation cases 3 are connected to each other by the connecting structure, which effectively strengthens the structural connection and provides high stability.

The accommodation case 3 on the top layer comprises at least one case cover 31 and a partition structure 32 extending in a horizontal direction, and the partition structure 32 is connected to the adjacent lower accommodation case. The connection between adjacent upper and lower accommodation cases 3 is achieved by the partition structure 32 extending in the horizontal direction, and each layer of the accommodation case 3 can accommodate battery modules 10, which realizes the arrangement of the battery modules 10 in the vertical direction, so that the space in the vertical direction is fully utilized, the accommodating number of the battery modules 10 is increased, therefore the capacity of the battery pack 1. Specifically, the number of the case covers 31 is three, and the three case covers 31 are located in three battery accommodating areas and cover the battery modules 10 in the one middle accommodating area 11 and the two side accommodating areas 12 respectively.

The battery pack for electric vehicle also comprises at least one lower casing 4. In this embodiment, the lower accommodation case comprises the lower casing 4, and the lower casing 4 is connected to the bottom surface of the partition structure 32, and a lower accommodating cavity 41 is formed between the lower casing 4 and the partition structure 32. The case cover 31 is connected to the top surface of the partition structure 32, and an upper accommodating cavity 311 is formed between the case cover 31 and the partition structure 32. In this embodiment, the number of partition structures 32 is one. The battery modules 10 in the three battery accommodating areas are separated up and down by the partition structure 32 to form a lower battery module and an upper battery module. The lower accommodating cavity 41 is used for accommodating the lower battery modules and the upper accommodating cavity 311 is used for accommodating the upper battery modules. The structure is simple and the installation and setting are very convenient. Of course, in other embodiments, the number of the partition structures 32 or lower casings 4 can be multiple and stacked along the height direction to increase the number of layers of the battery module 10.

The lower accommodating cavity 41 is used for accommodating the lower battery modules and the upper accommodating cavity 311 is used for accommodating the upper battery modules. Specifically, the lower battery modules are connected in series with each other, the upper battery modules are connected in series with each other, and the lower battery modules and the upper battery modules are connected in series with each other and are respectively arranged in the lower accommodating cavity 41 and the upper accommodating cavity 311, which are separated by the partition structure 32, so that wiring and installation are very convenient. The upper battery modules and the lower battery modules are connected in parallel with each other and then will be used to supply power to the electric vehicle, which can improve the power of the battery pack and increase the cruising range of the electric vehicle. The connection between the lower battery modules and the upper battery modules is not limited to the above-mentioned connection mode, and as long as the driving range of the electric vehicle is met, a reasonable connection mode can be selected according to the actual demand.

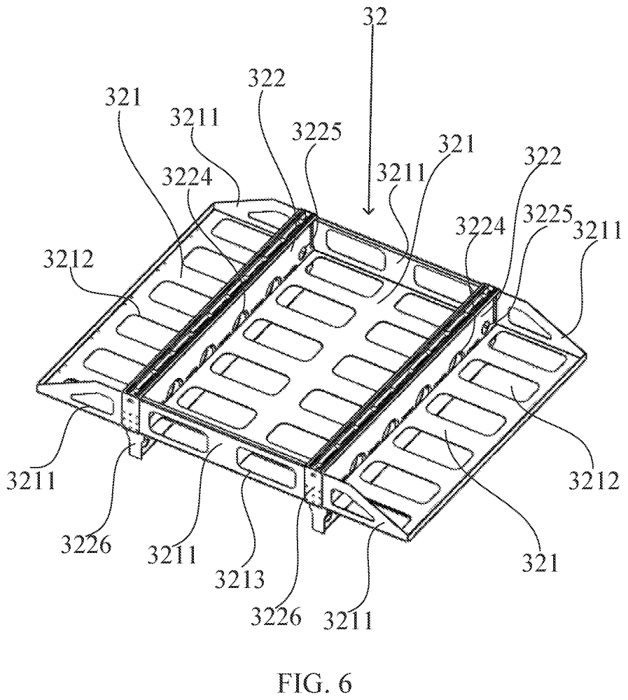

As shown in FIG. 5 and FIG. 6, the partition structure 32 comprises at least two partition frames 321, and the partition frames 321 are arranged at intervals along the width direction of the electric vehicle and used to accommodate the battery modules 10, and two adjacent partition frames 321 are connected by means of a gap connection structure 322 and form a gap. The partition frames 321 are used to carry the battery modules 10, and the partition frames 321 are connected by the gap connection structure 322 so that the battery modules 10 are arranged at intervals along the width direction of the electric vehicle. At the same time, the structure is connected with high strength, more stable and reliable.

At least one of the battery module 10 is accommodated on the partition frame 321 between the two gap connection structures 322. A space for placing at least one battery module 10 is formed between the two gap connection structures 322, the partition frame 321 and the case cover 31, and the battery modules 10 will be placed on the partition frame 321, which realizes high space utilization rate, increases the accommodating number of the battery modules 10, and improves the endurance mileage of the electric vehicle. Specifically, a first space for accommodating the battery modules 10 is formed by the space between the two gap connection structures 322, the partition frame 321 and the case cover 31, and second spaces for accommodating the battery modules 10 are respectively formed between the partition frame 321 and the case cover 31 located on the sides of the two gap connection structures 322 facing away from each other, and both the first space and the second space accommodate at least one battery module 10. In this embodiment, two second spaces respectively contain one battery module 10, the first space contains two battery modules 10, and the two battery modules 10 are arranged in the first space at intervals along the width direction of the electric vehicle. The battery modules 10 in the first space is separated from other adjacent battery modules 10 by means of the gap connection structure 322, the partition frame 321, and the case cover 31.

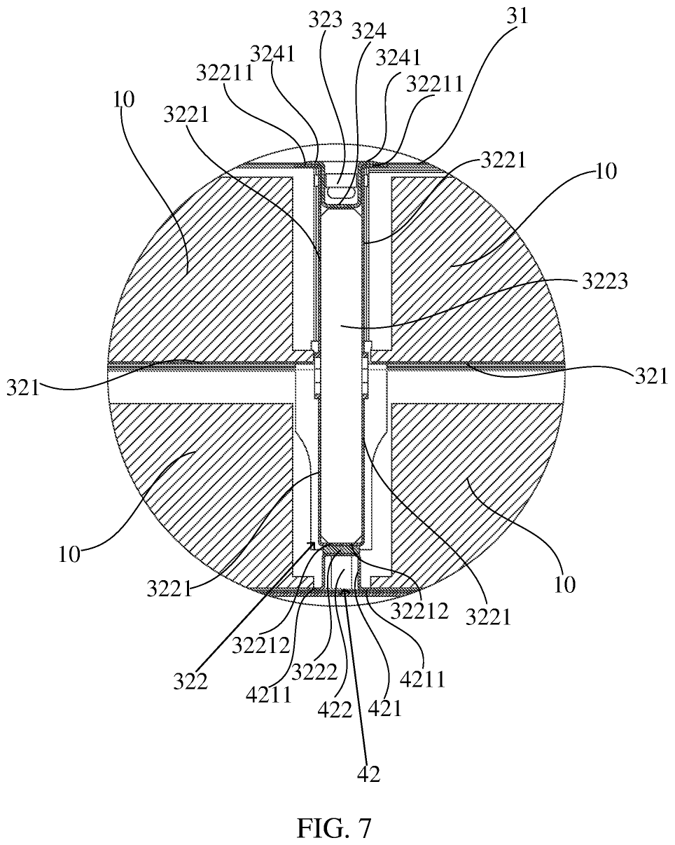

As shown in FIG. 5, FIG. 6 and FIG. 7, the gap connection structure 322 extends along the vertical direction and is connected to the adjacent lower accommodation case, and the gap connection structure 322 is provided with a number of locking connecting members 323 on top. The gap connection structure 322 extends along the vertical direction and is connected to the lower accommodation case, which makes the connection between the upper and lower layers of the accommodation case stable, and makes the battery pack case compact in structure, in addition, the gap connecting structure 322 can separate the upper and lower accommodation cases, and separate the multiple layers of battery modules 10 arranged along the width direction of the electric vehicle in the horizontal direction, which ensure the safety and stability of the battery modules 10. At the same time, a number of the locking connecting members 323 will be arranged at the top of the gap connection structure 322 and used for locking cooperation with the locking mechanism 101 at the bottom of the vehicle body beam 100, so that the space below the vehicle body beam 100 can be utilized, the battery pack for electric vehicle can accommodated more battery modules 10, the electric vehicle can travel longer, and the replacement times of the battery pack can be reduced. The center of gravity of the battery pack for electric vehicle can be effectively lowered, which increases the stability of the battery pack for electric vehicle and improves the stability and safety of the electric vehicle with a large space.

As shown in FIG. 11, the electric vehicle includes a quick-change bracket, which can be installed on the vehicle body beam 100 of the electric vehicle or on the chassis of the electric vehicle. The locking mechanism 101 is arranged at the bottom of the quick-change bracket, and the battery pack is locked on the locking mechanism 101 by a locking connection structure 2, thus realizing the installation and connection of battery pack.

The locking mechanism 101 comprises a locking base, which has an opening that extends in the vertical direction and a locking groove that extends in the horizontal direction from the opening. The opening is used for a locking connecting member 323 installed in the battery pack to enter the locking groove, so that the locking connecting member 323 can be hung in the locking groove.

The locking mechanism 101 further comprises a locking tongue, which is rotatably connected to the locking base. In the locked state, the locking tongue gets into the locking groove and is used to prevent the locking connecting member 323 from detaching from the locking groove. Wherein, the locking tongue closely abuts against the outer surface of the locking connecting member 323 to prevent the locking connecting member 323 from detaching from the locking groove, and the locking mechanism 101 cooperates with the locking connecting member 323 to lock the battery pack.

A number of the locking connecting members 323 are connected to the gap connection structure 322 by means of a U-shaped connecting plate 324, and two ends of the locking connecting member 323 are threaded through the U-shaped connecting plate 324. A number of the locking connecting members 323 are installed on the U-shaped connecting plate 324, and then the U-shaped connecting plate 324 is installed on the gap connection structure 322, so as to install and connect a number of the locking connecting members 323. At the same time, the two ends of the locking connecting member 323 are fixed on two sides of the U-shaped connecting plate 324 respectively, so that the locking connecting members 323 can achieve bilateral suspension when it is locked with the locking mechanism, which makes the locking more stable and reliable. The overall installation of the locking connecting members 323 improves the locking accuracy.

Two ends of the top of the U-shaped connecting plate 324 are both provided with a first bending part 3241 extending in the horizontal direction, and the two first bending parts 3241 extend in opposite directions and respectively abut against the gap connection structure 322. The first bending parts 3241 will abut against the top of the gap connection structure 322 and connect with the gap connection structure 322, so that the contact area is larger, the connecting strength between the U-shaped connecting plate 324 and the gap connection structure 322 is effectively strengthened, and the locking stability of the electric vehicle is improved. At the same time, the structure is simple and easy to be processed and manufactured. As shown in FIG. 7, the gap connection structure 322 comprises two division parts 3221 arranged at intervals, and the division parts 3221 extend along the length direction of the electric vehicle and extend in the vertical direction to connect with the adjacent lower accommodation case, and the gap is located between the two division parts 3221. Two adjacent battery modules 10 arranged along the width direction of the electric vehicle are divided by two arranged-apart division parts 3221, and a gap is formed between the two division parts 3221, and the U-shaped connecting plate 324 and a number of the locking connecting members 323 are arranged in the gap, so that the space utilization rate is higher, and the connecting strength is high and the structure is simple.

The top of the division part 3221 is provided with a second bending part 32211 extending outward in the horizontal direction, and the second bending parts 32211 of the two division parts 3221 extend in opposite directions and abut against the top surface of the case cover 31. The division part 3221 is connected to the top surface of the case cover 31 by means of the second bending part 32211, which makes the contact area larger, effectively strengthens the connecting strength of the case cover 31 and the gap connection structure 322, and improves the stability of the battery pack for electric vehicle. At the same time, the structure is simple and easy to be processed and manufactured. Wherein, the division part 3221 is attached and connected to the first bending part 3241 by means of the second bending part 32211.

The bottom of the division part 3221 is provided with a third bending part 32212 extending inward in the horizontal direction, and the third bending parts 32212 of the two division parts 3221 are oppositely arranged and connected to the bottom surface of the lower accommodation case. The division part 3221 is connected to the bottom surface of the lower accommodation case by means of the third bending section 32212, which makes the contact area larger, effectively strengthens the connecting strength between the lower accommodation case and the gap connection structure 322, and improves the stability of the battery pack for electric vehicle. At the same time, the structure is simple and easy to be processed and manufactured. In this embodiment, the gap connection structure 322 is connected to the lower casing 4 below.

In other embodiments, the gap connecting structure 322 further comprises a cover plate, two sides of which are respectively connected with the tops of the two division parts 3221, and the top surface of the cover plate is flush with the top surface of the top accommodation case, and the cover plate is provided with a through hole corresponding to the locking connecting member 323, so that the locking connecting member 323 can expose from the through hole, and the locking mechanism can pass through the through hole on the cover plate and cooperate with the locking connecting member 323.

As shown in FIG. 7, the gap connection structure 322 also comprises a connecting block 3222, which is located at the bottom of the gap connection structure 322 and is used to connect the gap connection structure 322 with the adjacent lower accommodation case. Specifically, the third bending parts 32212 of the two division parts 3221 are opposite to each other and connected to the top surface of the connecting block 3222, and the bottom surface of the connecting block 3222 is connected to the adjacent lower accommodation case. The connecting block 3222 has the function of a cushion block, which ensures that the lower accommodating cavity 41 can accommodate the lower battery modules, and realizes that the gap connection structure 322 is stably connected to the lower casing 4 by means of the connecting block 3222. At the same time, it is convenient to install and connect.

As shown in FIG. 5, FIG. 6 and FIG. 7, the gap connection structure 322 further comprises a first reinforcing plate 3223, and the first reinforcing plate 3223 is located at the gap and connected with the two division parts 3221. The first reinforcing plate 3223 has a strengthening effect, which effectively strengthens the overall structural connecting strength of the gap connection structure 322 and improves the stability of the battery pack for electric vehicle.

Wherein, the first reinforcing plate 3223 is located in the gap, which makes the structure more compact and does not occupy additional space. The bottom of the first reinforcing plate 3223 is connected to the third bending part 32212 of the two division parts 3221. The top of the first reinforcing plate 3223 is connected to the U-shaped connecting plate 324, which achieves higher structural and connecting strength. The number of the first reinforcing plates 3223 is several.

As shown in FIG. 4 and FIG. 6, the gap connection structure 322 further comprises an end sealing plate 3226, which is connected to the ends of two division parts 3221 arranged at intervals. The end sealing plate 3226 is used to seal the gap between the two division parts 3221, which effectively prevents external impurities from entering the gap, and has a good anti-corrosion effect. At the same time, it effectively strengthens the connecting strength between structures, which further improves the stability of the battery pack. Wherein, the end sealing plate 3226 extends downwards straight from the top of the two division parts 3221 to the bottom of the two division parts 3221. The two sides of the end sealing plate 3226 are connected to the adjacent partition frames 321.

As shown in FIG. 4, the partition structure 32 further comprises a plurality of connecting beams 325, which pass through and are connected to the gap connection structure 322, and the connecting beams 325 are connected to at least two of the partition frames 321. The connecting beam 325 has a strengthening function, and the adjacent two partition frames 321 are connected by means of the gap connection structure 322, and the connecting beams 325 pass through the gap connection structure 322 and are connected to a plurality of partition frames 321, which further strengthens the connecting strength of multiple partition frames 321 and improves the stability of the battery pack for electric vehicle.

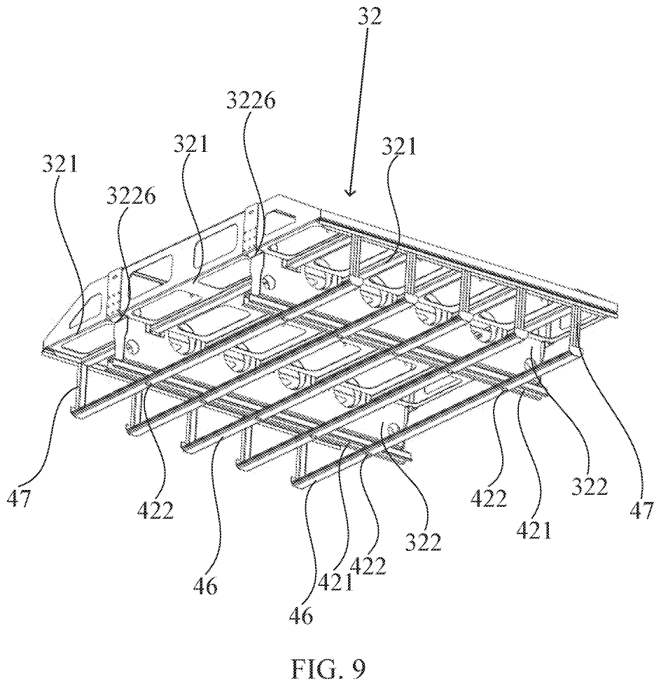

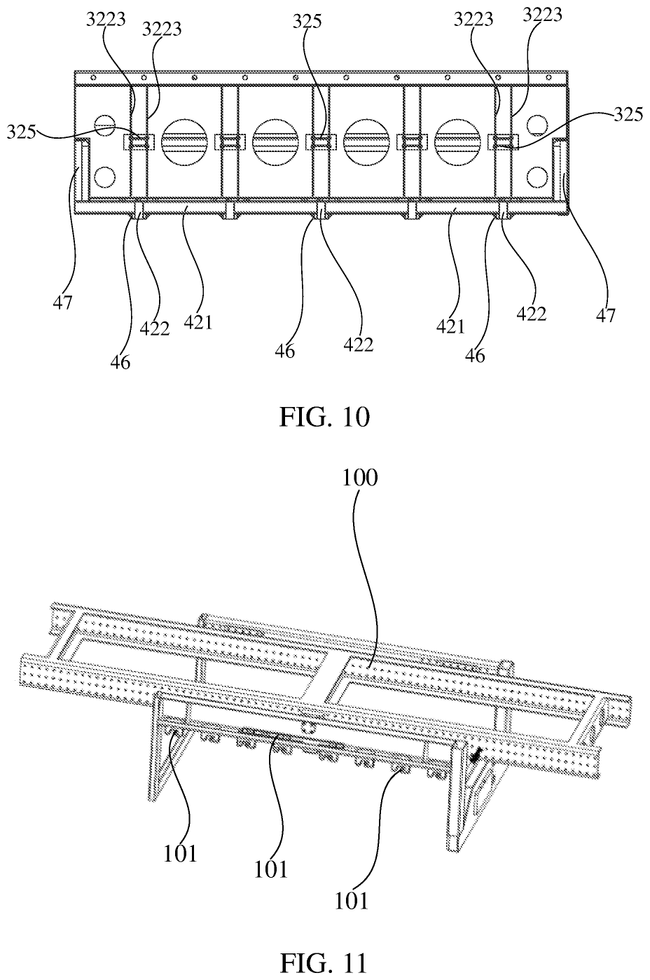

As shown in FIG. 9 and FIG. 10, the bottom surface of the lower casing 4 is provided with a plurality of first reinforcing ribs 46, and the first reinforcing ribs 46 are arranged corresponding to the connecting beams 325 in the vertical direction. The first reinforcing plates 3223 extend in the vertical direction and are arranged corresponding to the connecting beams 325, and each connecting beam 325 is provided with two first reinforcing plates 3223, which are connected to both sides of each connecting beam 325, and the bottoms of the two first reinforcing plates 3223 are connected to the lower casing 4 and correspond to the first reinforcing ribs 46 on the bottom surface of the lower casing 4, and the connecting beams 325 are connected to the partition structure 32 and the first reinforcing plates 3223, effectively strengthening the structural connecting strength and improving the stability of the battery pack.

As shown in FIG. 6, two ends of the partition frame 321 are both provided with a second reinforcing plate 3211, and the two second reinforcing plates 3211 are respectively connected to two ends of the division part 3221. The second reinforcing plate 3211 has a strengthening effect, which effectively strengthens the connecting strength of the partition frame 321 and the gap connection structure 322, and improves the stability of the battery pack for electric vehicle. At the same time, the second reinforcing plates 3211 have the function of shielding and isolating, and the battery modules 10 placed on the partition frame 321 will be located between two second reinforcing plates 3211. Wherein, the end sealing plate 3226 is connected to two adjacent second reinforcing plates 3211.

Wherein, the partition frame 321 is provided with a first lightening hole 3212. The number of the first lightening holes 3212 is multiple, and multiple first lightening holes 3212 are arranged on the partition frame 321 at intervals, thereby realizing the lighter weight of the battery pack for electric vehicle. The gap connection structure 322 is provided with a second lightening hole 3224. The number of the second lightening holes 3224 is multiple, and multiple second lightening holes 3224 are arranged on the gap connection structure 322 at intervals, thereby further realizing the lighter weight of the battery pack for electric vehicle.

The partition frame 321 is provided with a first wire-passing hole 3213. The first wire-passing hole 3213 will be used for the passage of cables, so that the upper battery modules and the lower battery modules can be connected in parallel through the first wire-passing hole 3213, which is very convenient to install and connect. The gap connection structure 322 is provided with a second wire-passing hole 3225. The second wire-passing hole 3225 will be used for the passage of cables, so that two adjacent upper battery modules can be connected in series through the second wire-passing hole 3225, two adjacent lower battery modules can be connected in series through the second wire-passing hole 3225, which is very convenient to install and connect.

As shown in FIG. 7, the lower casing 4 is internally provided with a matching structure 42 connected with the gap connection structure 322. The matching structure 42 extends and bulges upward in the lower casing 4, and the bottom of the gap connection structure 322 is installed and connected to the matching structure 42 in the lower casing 4 by means of the connecting block 3222, which provides high connecting strength and is convenient for installation and connection.

Specifically, the matching structure 42 comprises an inverted U-shaped plate 421 and a connecting pillar 422, two ends of the bottom of the inverted U-shaped plate 421 are both provided with a fourth bending part 4211 extending in the horizontal direction, and the two fourth bending parts 4211 extend in opposite directions and respectively abut against the lower casing 4, and the connecting pillar 422 is located within the inverted U-shaped plate 421, and the bottom of the connecting pillar 422 is connected to the lower casing 4, and the top of the connecting pillar 422 is connected to the top of the inverted U-shaped plate 421 and the bottom of the gap connection structure 322.

The inverted U-shaped plate 421 is connected to the lower casing 4 by means of the fourth bending part 4211 at two ends, which makes the contact area larger, effectively strengthens the overall structural connecting strength of the lower casing 4 and improves the stability of the battery pack for electric vehicle. At the same time, the connecting pillar 422 is arranged in the inverted U-shaped plate 421, the bottom of the connecting pillar 422 is connected with the bottom of the lower casing 4 s, and the top of the connecting pillar 422 is connected with the inverted U-shaped plate 421 and the connecting block 3222 by means of fastener, so that the installation and connection are very convenient, and the structural connecting strength can be strengthened through the connecting pillar 422, thus further improving the stability of the battery pack for electric vehicle.

As shown in FIG. 9 and FIG. 10, the connecting pillar 422 passes through the first reinforcing rib 46 at the bottom of the lower casing 4, and the connecting pillar 422 is provided with a through hole, and the bolt will pass through the through hole from the bottom of the lower casing 4 and connect with the inverted U-shaped plate 421 and the gap connection structure 322, so that the installation and connection are very convenient and the connecting strength is high. At the same time, the connecting pillar 422 closely abuts against the inverted U-shaped plate 421 and the bottom surface of the lower casing 4, so that the battery pack can be sealed, and it has a good anti-corrosion effect on the inside of the battery pack.

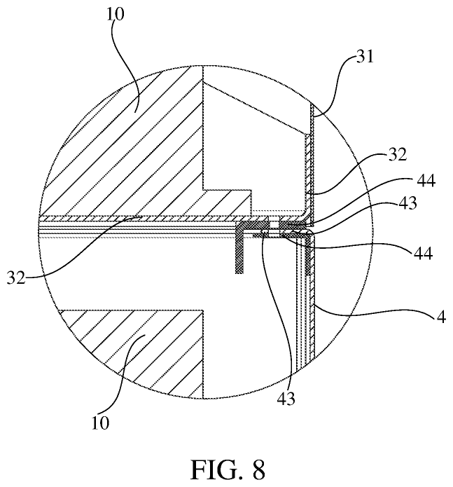

As shown in FIG. 5 and FIG. 8, the top of two side walls extending along the length direction of the battery pack for electric vehicle on the lower casing 4 are both provided with extension parts 43 extending inward in the horizontal direction, and the extension parts 43 are connected with the bottom surface of the partition structure 32. The extension part 43 extending inward along the horizontal direction is attached and connected to the bottom surface of the partition structure 32, which effectively strengthens the connecting strength between the lower casing 4 and the partition structure 32, and improves the stability of the battery pack for electric vehicle.

The extension part 43 and/or the partition structure 32 are provided with a thickened plate 44, the thickened plate 44, the extension part 43 and the partition structure 32 are connected by fasteners. The thickened plate 44 can effectively strengthen the local structural strength between the extension part 43 and the partition structure 32, and the thickened plate 44, the extension part 43 and the partition structure 32 are connected by fasteners, which further strengthens the connecting strength between the lower casing 4 and the partition structure 32 and improves the stability of the battery pack for electric vehicle.

In this embodiment, the number of the thickened plate 44 is two, and the two thickened plates 44 are welded to the extension part 43 and the partition structure 32 respectively, and the shape of the thickened plate 44 is L-shaped, wherein one thickened plate 44 is welded to the inner surface of the lower casing 4, and the other thickened plate 44 has a transverse part welded to the bottom surface of the partition structure 32, and a longitudinal part extends into the lower casing 4.

There is a partition plate within the lower casing 4, which can effectively strengthen the overall structural strength of the lower casing 4. At the same time, the partition plate is used to separate the two adjacent battery modules in the lateral direction, which provides higher safety and stability.

As shown in FIGS. 9 and 10, the lower casing 4 is provided with a plurality of second reinforcing ribs 47, which are connected to the inner side wall of the lower casing 4 and the bottom surface of the extension part 43. The second reinforcing ribs 47 will further strengthen the overall structural strength of the lower casing 4, resulting in higher safety and stability. Wherein, the positions of the second reinforcing ribs 47 are arranged corresponding to the positions of the first reinforcing ribs 46.

As shown in FIG. 2 and FIG. 3, the position of the lower casing 4 corresponding to the gap is provided with an upward extending sealing plate 45, and the sealing plate 45 covers the gap at the corresponding position and is connected with the gap connection structure 322. Wherein, the upper end of the sealing plate 45 extends to the corresponding gap and is connected to two division parts 3221 arranged at intervals, and the lower end of the sealing plate 45 extends downwards to the bottom surface of the lower casing 4 and is connected to the bottom surface of the lower casing 4. The lower casing 4 is connected to the upper accommodation case 3 as a whole by means of the sealing plate 45, which further improves the structural strength of the interconnection of the multiple layers of accommodation cases 3 and ensures the overall strength of the battery pack for electric vehicle. In this embodiment, the number of the sealing plate 45 is four, two of which are respectively located at the front and rear ends of the battery pack for electric vehicle, covering the front and rear ends of the gap.

As shown in FIG. 2, FIG. 3 and FIG. 4, the battery pack for electric vehicle further comprises a battery-side electrical connector 5 for electrical connection with a vehicle-side electrical connector, and the battery-side electrical connector 5 is connected to the accommodation case 3 and electrically connected with multiple layers of the battery modules 10. Battery-side electrical connector 5 is electrically connected to the vehicle-side electrical connector and used to supply power to the electric vehicle.

The battery pack for the electric vehicle further comprises a battery-side liquid-cooled connector 6 for connecting with a vehicle-side liquid-cooled connector, and the battery-side liquid-cooled connector 6 is arranged on the accommodation case 3. The battery-side liquid-cooled connector 6 is connected to the vehicle-side liquid-cooled connector to cool the battery pack for electric vehicle.

Although the specific embodiments of the present disclosure are described above, it should be understood by those skilled in the art that this is only an example, and the scope of protection of the present disclosure is defined by the appended claims. Those skilled in the art can make various changes or modifications to these embodiments without departing from the principles and essence of the present disclosure, but these changes and modifications fall into the scope of protection of the present disclosure.

1. A battery pack for electric vehicle, wherein, it comprises:
a plurality of battery accommodating areas, arranged in a width direction of the electric vehicle, the plurality of the battery accommodating areas comprises a middle accommodating area and a side accommodating area, each of the battery accommodating area accommodates multiple layers of battery modules;
locking connection structure, matching a locking mechanism on the electric vehicle to lock the battery pack to the electric vehicle, the locking connection structure is located in the area between the middle accommodating area and the side accommodating area or the locking connection structure is located above the area between the middle accommodating area and the side accommodating area.

2. The battery pack for electric vehicle according to claim 1, wherein, the battery pack for electric vehicle comprises multiple layers of accommodation cases, each of the accommodation case is used to accommodate the battery modules, and two adjacent layers of the accommodation cases are connected to each other by a connecting structure.

3. The battery pack for electric vehicle according to claim 2, wherein, the accommodation case on the top layer comprises at least one case cover and a partition structure extending horizontally, and the partition structure is connected to adjacent lower accommodation case.

4. The battery pack for electric vehicle according to claim 3, wherein, the partition structure comprises at least two partition frames, the partition frames are arranged at intervals in the width direction of the electric vehicle and used to accommodate the battery modules, and the two adjacent partition frames are connected by means of a gap connection structure and form a gap.

5. The battery pack for electric vehicle according to claim 4, wherein, at least one of the battery module is accommodated on the partition frame between the two gap connection structures.

6. The battery pack for electric vehicle according to claim 4, wherein, the gap connection structure extends in a vertical direction and is connected to an adjacent lower accommodation case, and the gap connection structure is provided with a number of locking connecting members on top.

7. The battery pack for electric vehicle according to claim 6, wherein, a number of the locking connecting members are connected to the gap connection structure by means of a U-shaped connecting plate, and two ends of the locking connecting member are threaded through the U-shaped connecting plate.

8. The battery pack for electric vehicle according to claim 7, wherein, two ends of the top of the U-shaped connecting plate are both provided with a first bending part extending in a horizontal direction, and the two first bending parts extend in opposite directions and respectively abut against the gap connection structure.

9. The battery pack for electric vehicle according to claim 4, wherein, the gap connection structure comprises two division parts arranged at intervals, the division parts extend in the length direction of the electric vehicle, and the gap is located between the two division parts.

10. The battery pack for electric vehicle according to claim 9, wherein, the top of the division part is provided with a second bending part extending outward in the horizontal direction, and the second bending parts of the two division parts extend in opposite directions and abut against the top surface of the case cover;
and/or, the bottom of the division part is provided with a third bending part extending inward in the horizontal direction, and the third bending parts of the two division parts are oppositely arranged and connected to the bottom surface of the lower accommodation case.

11. The battery pack for electric vehicle according to claim 9, wherein, the gap connection structure further comprises a first reinforcing plate, and the first reinforcing plate is located at the gap and connected with the two division parts;
and/or, two ends of the partition frame are both provided with a second reinforcing plate, and the two second reinforcing plates are respectively connected to two ends of the division part.

12. The battery pack for electric vehicle according to claim 4, wherein, the partition frame is provided with a first lightening hole and/or a first wire-passing hole, and/or, the gap connection structure is provided with a second lightening hole and/or a second wire-passing hole.

13. The battery pack for electric vehicle according to claim 4, wherein, the partition structure further comprises a connecting beam, the connecting beam passes through and is connected to the gap connection structure, and the connecting beam is connected to at least two of the partition frames.

14. The battery pack for electric vehicle according to claim 4, wherein, the battery pack for electric vehicle further comprises at least one lower casing, the lower casing is connected to the bottom surface of the partition structure, and a lower accommodating cavity is formed between the lower casing and the partition structure, and the case cover is connected to the top surface of the partition structure, and an upper accommodating cavity is formed between the case cover and the partition structure.

15. The battery pack for electric vehicle according to claim 14, wherein, the lower casing is internally provided with a matching structure connected with the gap connection structure, and the matching structure comprises an inverted U-shaped plate and a connecting pillar, wherein two ends of the bottom of the inverted U-shaped plate are both provided with a fourth bending part extending in the horizontal direction, and the two fourth bending parts extend in opposite directions and respectively abut against the lower casing, and the connecting pillar is located within the inverted U-shaped plate, and the bottom of the connecting pillar is connected to the lower casing, and the top of the connecting pillar is connected to the top of the inverted U-shaped plate and the bottom of the gap connection structure.

16. The battery pack for electric vehicle according to claim 14, wherein, the top of two side walls extending in the length direction of the battery pack for electric vehicle on the lower casing are both provided with extension parts extending inward in the horizontal direction, and the extension parts are connected with the bottom surface of the partition structure.

17. The battery pack for electric vehicle according to claim 16, wherein, the extension part and/or the partition structure are provided with a thickened plate, the thickened plate, the extension part and the partition structure are connected by fasteners.

18. The battery pack for electric vehicle according to claim 14, wherein, the position of the lower casing corresponding to the gap is provided with an upward extending sealing plate, and the sealing plate covers the gap at the corresponding position and is connected with the gap connection structure.

19. The battery pack for electric vehicle according to claim 2, wherein, the battery pack for electric vehicle further comprises a battery-side electrical connector for electrical connection with a vehicle-side electrical connector, and the battery-side electrical connector is connected to the accommodation case and electrically connected with multiple layers of the battery modules;
and/or, the battery pack for the electric vehicle further comprises a battery-side liquid-cooled connector for connecting with a vehicle-side liquid-cooled connector, and the battery-side liquid-cooled connector is arranged on the accommodation case.

20. An electric vehicle, wherein it comprises the battery pack for electric vehicle according to claim 1, and the battery pack for electric vehicle is removably connected to the electric vehicle.
